(19) United States
(12) Patent Application Publication
(10) Pub. No.: US 2004/0205240 A1
(43) Pub. Date: Oct. 14, 2004

(54) Method, system, and computer program product for providing a four-tier corba architecture

(75) Inventors: Rhonda L. Childress, Austin, TX (US); Michael Bruce Oliver, Nicholasville, KY (US); Neil Raymond Pennell, Austin, TX (US); Cindy Marie Uanino, Crofton, MD (US)

Correspondence Address: Duke W. Yee,, Carstens, Yee & Cahoon, LLP, P.O. Box 802334, Dallas, TX, 75380, US

(73) Assignee: International Business Machines Corporation, Armonk, NY

(21) Appl. No.: 10/302,523

(22) Filed: Nov. 21, 2002

(51) Int. Cl. G06F 15/173; G06F 9/00; G06F 9/46

(52) U.S. Cl. 709/244; 719/316

(57) ABSTRACT

A system, method, and computer program product are disclosed for providing a four-tier CORBA architecture. A three-tier CORBA network is provided. The three-tier CORBA network includes a first CORBA ORB coupled to a second CORBA ORB, and the second CORBA ORB coupled to a third CORBA ORB. The first CORBA ORB occupies a first level of a network hierarchy. The second CORBA ORB occupies a second level of the network hierarchy. And, the third CORBA ORB occupies a third level of the network hierarchy. A global CORBA ORB is coupled to the three-tier CORBA network, wherein the global CORBA ORB occupies a top level of the network hierarchy.

### BACKGROUND OF THE INVENTION

1. Technical Field

The present invention relates generally to the field of computer systems, and more specifically to a data processing system, method, and computer program product for providing a four-tier CORBA architecture.

2. Description of Related Art

Object-oriented programming (OOP) has emerged as a powerful new programming tool that enables the rapid development and implementation of functionality while permitting the customization and reuse of objects. The Object Management Group (OMG, an international organization for promoting the theory and practice of object-oriented software technology) defines an industry standard architecture for a distributed object computing environment, called the Object Management Architecture (OMA). The OMA provides a conceptual infrastructure upon which all of the OMG's specifications are based.

OMG defines a structure to allow integration of a wide variety of object systems called the Common Object Request Broker Architecture (CORBA). The CORBA model consists of the Object Request Broker (ORB), CORBA services, CORBA facilities and Application Objects. These components make up the primary pieces of CORBA.

A CORBA ORB is a particular type of computer system that provides particular capabilities that are defined by the CORBA specification. In order to function as a CORBA ORB, a computer system must comply with the CORBA specification. Computer systems that do not comply with the CORBA specification for being a CORBA ORB are not classified as CORBA ORBs. These computer systems that do not comply with the CORBA specification for being a CORBA ORB, however, may be coupled to the data processing system as clients and/or servers.

A problem may arise in a CORBA environment because the environment is limited by the CORBA specification to being only a three-tier CORBA ORB system. The specification provides for three levels of CORBA ORBs to be coupled together. Other computer systems, such as servers and clients, may also be coupled to one or more of the CORBA ORBs. These other computer systems do not make up a level of the CORBA ORB architecture, however. The specification provides for only three levels of CORBA ORBs, and does not permit four levels of CORBA ORBs coupled together in a network.

FIG. 1 is a block diagram illustrating a CORBA data processing system 100 in accordance with the prior art that complies with the CORBA standard. CORBA data processing system 100 includes three separate CORBA networks 101, 103, and 105. The CORBA specification provides for only three tiers of CORBA ORB computer systems. Therefore, each network includes only three levels, or tiers, of CORBA ORB computer systems.

CORBA network 101 includes CORBA ORBs 102, 108, 110, 120, 122, and 124. CORBA network 103 includes CORBA ORBs 104, 112, 114, 126, 128, and 130. And, CORBA network 105 includes CORBA ORBs 106, 116, 118, 132, 134, and 136.

CORBA ORBs 102, 104, and 106 all occupy a first level, or tier. CORBA ORBs 108, 110, 112, 114, 116, and 118 all occupy a second level, which is below the first level. CORBA ORBs 120, 122, 124, 126, 128, 130, 132, 134, and 136 all occupy a third level, which is below the second level. Servers and clients may be, and typically are, coupled to one or more of the CORBA ORBs. For example, servers 138 and 140 are coupled to CORBA ORB 134. Clients 142, 144, and 146 are coupled to server 138.

A user may wish to transmit data to all of the computer systems in CORBA data processing system 100. For example, when a user desires to distribute a software application to each computer system in CORBA data processing system 100, the user must first manually install the software application on the first level CORBA ORB in each CORBA network. Then, from each first level CORBA ORB, the user must initiate an action to distribute the software application to each CORBA ORB, and servers and clients, in the network.

Thus, the software application must be manually installed on CORBA ORBs 102, 104, and 106. Then, using CORBA ORB 102, the user must initiate an action that will distribute the application to CORBA ORBS 108 and 110, which in turn will distribute the application to CORBA ORBs 120, 122, and 124. The user must then go to CORBA ORB 104 in order to initiate an action from CORBA ORB 104 that will distribute the application to CORBA ORBS 112 and 114, which in turn will distribute the application to CORBA ORBs 126, 128, and 130. Finally, the user must go to CORBA ORB 106 in order to initiate an action from CORBA ORB 106 that will distribute the application to CORBA ORBS 116 and 118, which in turn will distribute the application to CORBA ORBs 132, 134, and 136. CORBA ORB 134 will then distribute the software application to server 138, and ultimately to clients 142, 144, and 146.

This time-consuming process is required because second level CORBA ORBs are limited by the CORBA specification from transmitting names of third level CORBA ORBs to a level above the first level.

Thus, the CORBA specification allows CORBA ORB 108, for example, to transmit names of third level CORBA ORBs, i.e. 120, 122, and 124, to CORBA ORB 102. The CORBA specification, however, explicitly prohibits CORBA ORB 108, for example, from transmitting names of third level CORBA ORBs, i.e. 120, 122, and 124, to any computer system that a user might attempt to install in the hierarchy above CORBA ORB 102.

Therefore, a need exists for a method, system, and computer program product for providing a four-tier CORBA architecture.

### SUMMARY OF THE INVENTION

A system, method, and computer program product are disclosed for providing a four-tier CORBA architecture. A three-tier CORBA network is provided. The three-tier CORBA network includes a first CORBA ORB coupled to a second CORBA ORB, and the second CORBA ORB coupled to a third CORBA ORB. The first CORBA ORB occupies a first level of a network hierarchy. The second CORBA ORB occupies a second level of the network hierarchy. And, the third CORBA ORB occupies a third level of the network hierarchy. A global CORBA ORB is coupled to the three-tier CORBA network, wherein the global CORBA ORB occupies a top level of the network hierarchy. The global CORBA ORB functions as a CORBA ORB in accordance with the CORBA specification and manages the first CORBA ORB as a managed node.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram illustrating a three-tier CORBA architecture in accordance with the prior art;

FIG. 2 is a block diagram depicting a four-tier CORBA architecture in accordance with the present invention;

FIG. 3 is a block diagram illustrating a data processing system that may be utilized to implement a server, client, object request broker, or any other computer system in accordance with the present invention;

FIG. 4 illustrates a high level flow chart which depicts a global CORBA object request broker (ORB) managing multiple levels of CORBA ORB systems in accordance with the present invention; and

FIG. 5 depicts a high level flow chart which illustrates a CORBA ORB executing tasks received from a global CORBA ORB in accordance with the present invention.

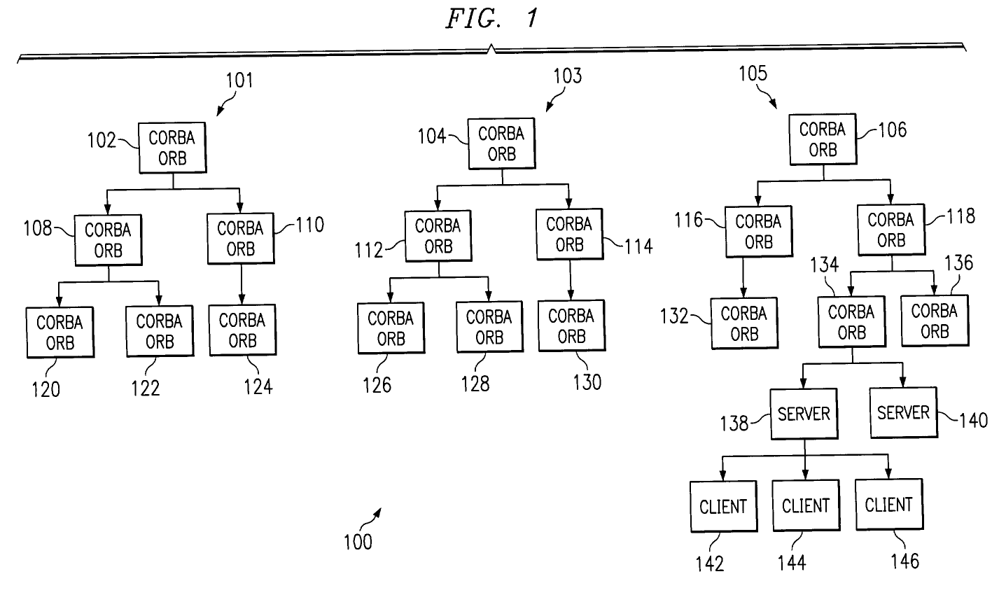

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, system, and computer program product for providing a four-tier CORBA architecture. This four-tier architecture is provided by adding a global CORBA ORB to a three-tier architecture. The three-tier architecture includes a first level, a second level, and a third level. The global CORBA ORB, then, occupies a top, global level. The top, or global level is above the first level of the three-tier architecture. The global CORBA ORB manages the first level of CORBA ORBs as managed nodes in accordance with the CORBA specification for CORBA ORBs.

The global CORBA ORB is capable of functioning as a fourth-tier by creating tasks that are downloaded to, and executed by, the first level CORBA ORBs. These tasks may be utilized to cause the first level CORBA ORB to execute any type of action. For example, a task may be downloaded from the global CORBA ORB, to be executed by a first level CORBA ORB, to distribute software to the CORBA ORBs in the second and third levels of the tier, and to the servers and clients managed by the second and third level CORBA ORBs.

Global tasks may be created and executed by the global CORBA ORB. A global task may, for example, cause other tasks to be downloaded to all or selected ones of the CORBA ORBs that occupy the first level of the hierarchy. The global CORBA ORB may also create manager tasks that are designed to be executed by one or more of the first level CORBA ORBs. These manager tasks are downloaded from the global CORBA ORB to the first level CORBA ORB. Once a first level CORBA ORB receives a manager task, the first level CORBA ORB will execute the manager task.

Tasks are well known routines that are described in detail by the CORBA specification. Tasks run only on CORBA ORBs.

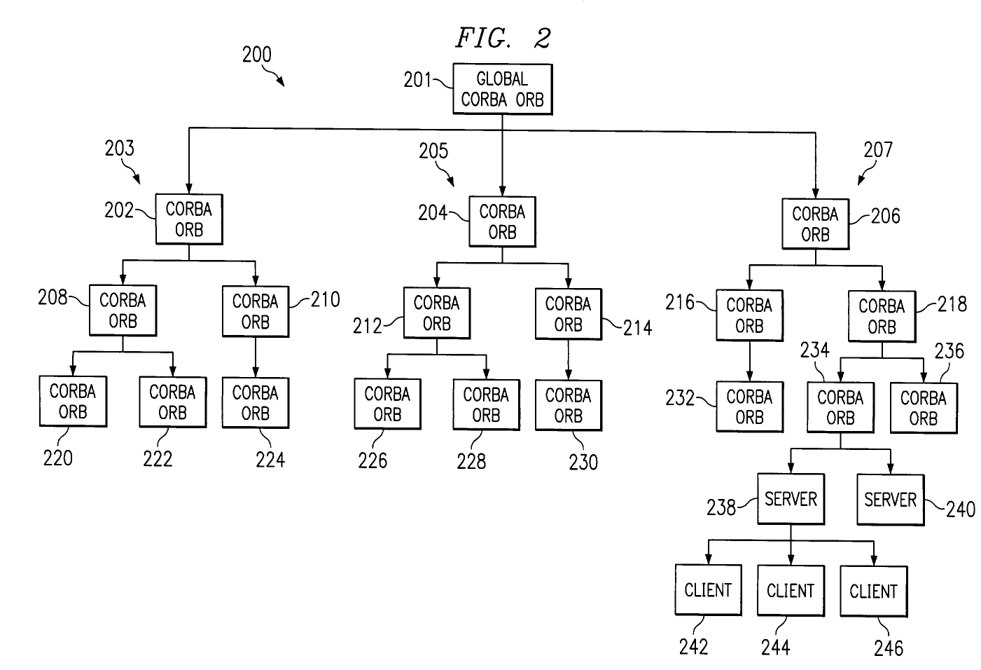

FIG. 2 is a block diagram depicting a four-tier CORBA architecture in accordance with the present invention. CORBA data processing system 200 includes three CORBA three-tier networks 201 coupled together utilizing a fourth-tier Global CORBA ORB 201. In accordance with the present invention, CORBA data processing system 200 includes four tiers of CORBA ORBs. CORBA ORB 201 occupies the top level, also referred to herein as the global level. The global level occupies the level above the first level in the hierarchy.

CORBA network 203 includes CORBA ORBs 202, 208, 210, 220, 222, and 224. CORBA network 205 includes CORBA ORBs 204, 212, 214, 226, 228, and 230. And, CORBA network 207 includes CORBA ORBs 206, 216, 218, 232, 234, and 236.

CORBA ORBs 202, 204, and 206 all occupy a first level. The first level is below the global level in the four-tier hierarchy. CORBA ORBs 208, 210, 212, 214, 216, and 218 all occupy a second level, which is below the first level. CORBA ORBs 220, 222, 224, 226, 228, 230, 232, 234, and 236 all occupy a third level, which is below the second level. Servers and clients may be, and typically are, coupled to one or more of the CORBA ORBs. For example, servers 238 and 240 are coupled to CORBA ORB 234. Clients 242, 244, and 246 are coupled to server 238.

Thus, the CORBA architecture depicted FIG. 2 is a four-tier architecture that includes a global level, and first, second, and third levels. The global level is the top level in the hierarchy and is above the first level.

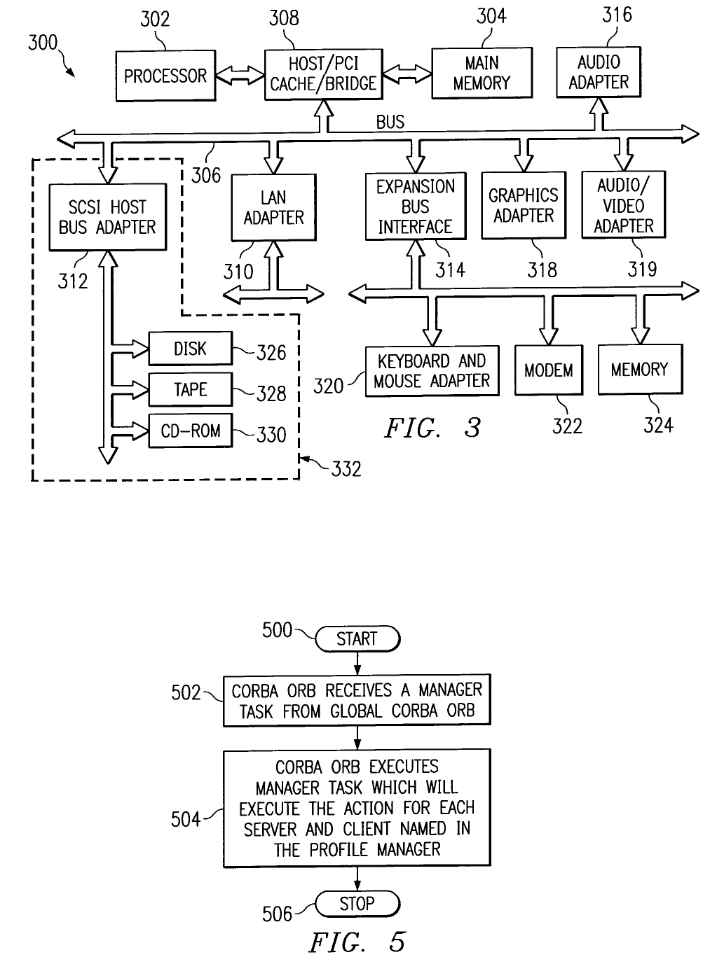

FIG. 3 is a block diagram illustrating a data processing system that may be utilized to implement a server, client, object request broker, or any other computer system in accordance with the present invention. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, network card 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

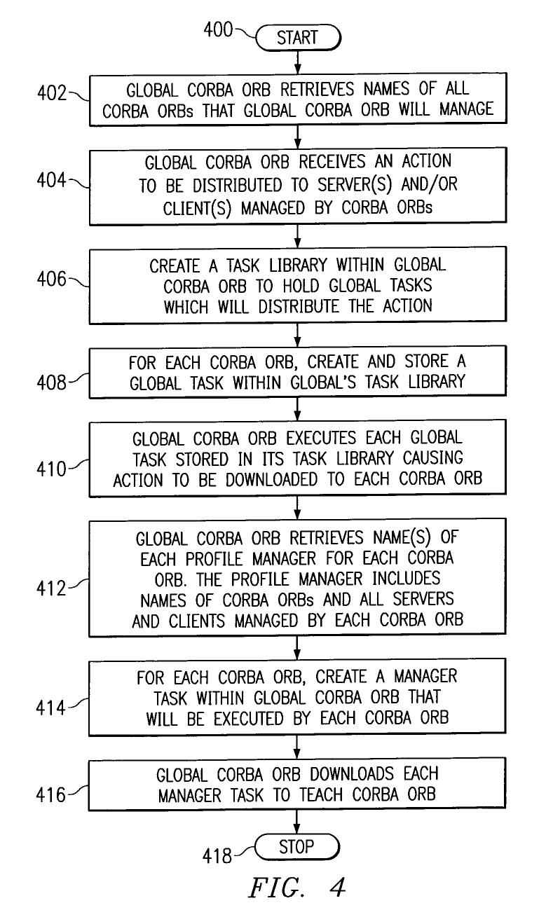

FIG. 4 illustrates a high level flow chart which depicts a global CORBA object request broker (ORB) managing multiple levels of CORBA ORB systems in accordance with the present invention. The process starts as depicted by block 400 and thereafter passes to block 402 which illustrates a global CORBA ORB retrieving names of all first level CORBA ORBs that the global CORBA ORB will manage. Thus, global CORBA ORB 201 will retrieve from CORBA ORBs 202, 204, and 206 their names. Next, block 404 depicts the global CORBA ORB receiving an action to be distributed to one or more of the server(s) and/or client(s) managed by the CORBA ORBs. The process then passes to block 406 which illustrates creating a task library within the global CORBA ORB to hold global tasks which will distribute the action. Thereafter, block 408 depicts creating and storing a global task within the global CORBA ORB's library for each first level CORBA ORB.

The process then passes to block 410 which illustrates the global CORBA ORB executing each global task that is stored in the global CORBA ORB's library, thus, causing the action to be downloaded to each first level CORBA ORB. Block 412, then, depicts the global CORBA ORB retrieving one or more names of each profile manager from each first level CORBA ORB. A profile manager that exists within a particular CORBA ORB includes the names of other CORBA ORBs and all servers and clients managed by the particular CORBA ORB. Thereafter, block 414 illustrates creating a manager task within the global CORBA ORB that will be executed by the first level CORBA ORBs. Next, block 416 depicts the global CORBA ORB downloading each manager task to each first level CORBA ORB. The process then terminates as illustrated by block 418.

FIG. 5 depicts a high level flow chart which illustrates a CORBA ORB executing tasks received from a global CORBA ORB in accordance with the present invention. The process starts as depicted by block 500 and thereafter passes to block 502 which illustrates a first level CORBA ORB receiving a manager task from the global CORBA ORB. Next, block 504 depicts the CORBA ORB executing the manager task which will execute the action for each server and client named in that CORBA ORB's profile manager. The process then terminates as illustrated by block 506.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for providing a four-tier CORBA architecture, said method comprising the steps of:
providing a three-tier CORBA network, said CORBA network including a first CORBA ORB coupled to a second CORBA ORB, said second CORBA ORB being coupled to a third CORBA ORB, wherein said first CORBA ORB occupies a first level of a network hierarchy, said second CORBA ORB occupies a second level of said network hierarchy, and said third CORBA ORB occupies a third level of said network hierarchy; and
coupling a global CORBA ORB to said three-tier CORBA network, said global CORBA ORB occupies a top level of said network hierarchy over said first level, said global CORBA ORB functioning as a CORBA ORB and treating said first CORBA ORB as a managed node.

2. The method according to claim 1, further comprising the steps of:
creating, on said global CORBA ORB, a manager task;
downloading, from said global CORBA ORB, said manager task to said first CORBA ORB; and
causing, by said global CORBA ORB, said first CORBA ORB to execute said manager task.

3. The method according to claim 2, further comprising the steps of:
creating, on said global CORBA ORB, a global task;
executing, by said global CORBA ORB, said global task; and
in response to executing said global task by said global CORBA ORB, downloading said manager task to said first CORBA ORB.

4. The method according to claim 2, further comprising the steps of:
creating, on said global CORBA ORB, said manager task to distribute a software application to said second and third CORBA ORBs;
downloading, from said global CORBA ORB, said manager task to said first CORBA ORB;
causing, by said global CORBA ORB, said first CORBA ORB to execute said manager task; and
in response to said first CORBA ORB executing said manager task, said first CORBA ORB distributing said software application to said second and third CORBA ORBs.

5. The method according to claim 1, further comprising the steps of:
providing said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy; and
retrieving, by said global CORBA ORB, names from said first plurality of first-level CORBA ORBs of said second-level and third level CORBA ORBs.

6. The method according to claim 5, further comprising the steps of:
creating, on said global CORBA ORB, a manager task;
downloading, from said global CORBA ORB, said manager task to said first plurality of first-level CORBA ORB; and
causing, by said global CORBA ORB, said first plurality of first-level CORBA ORBs to execute said manager task.

7. The method according to claim 6, further comprising the steps of:
creating said manager task to distribute a software application to said second plurality and third plurality of CORBA ORBs; and
in response to said first plurality of CORBA ORBs executing said manager task, said first CORBA ORBs distributing said software application to said second plurality and third plurality of CORBA ORBs.

8. The method according to claim 7, further comprising the steps of:
providing said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy;
obtaining, by said global CORBA ORB, a copy of a profile manager stored in ones of said first plurality of CORBA ORBs;
each said profile manager including names of ones of said second plurality and ones of said third plurality of CORBA ORBs;
creating, on said global CORBA ORB, a manager task;
downloading, from said global CORBA ORB, said manager task to said ones of said first plurality of CORBA ORB;
causing, by said global CORBA ORB, said ones of said first plurality of CORBA ORBs to execute said manager task; and
executing said manager task by said ones of said first plurality of CORBA ORBs which performs an action utilizing said ones of said second plurality and said ones of said third plurality of CORBA ORBs.

9. The method according to claim 1, further comprising the steps of:
obtaining, by said global CORBA ORB, a copy of a profile manager stored in said first CORBA ORB; and
said profile manager including a name of said second and third CORBA ORBs.

10. A data processing system for providing a four-tier CORBA architecture, comprising:
a three-tier CORBA network, said CORBA network including a first CORBA ORB coupled to a second CORBA ORB, said second CORBA ORB being coupled to a third CORBA ORB, wherein said first CORBA ORB occupies a first level of a network hierarchy, said second CORBA ORB occupies a second level of said network hierarchy, and said third CORBA ORB occupies a third level of said network hierarchy; and
a global CORBA ORB coupled to said three-tier CORBA network, said global CORBA ORB occupies a top level of said network hierarchy over said first level, said global CORBA ORB functioning as a CORBA ORB and treating said first CORBA ORB as a managed node.

11. The system according to claim 10, further comprising:
said global CORBA ORB receiving a manager task created within said global CORBA ORB;
said global CORBA ORB downloading said manager task to said first CORBA ORB; and
said global CORBA ORB for causing said first CORBA ORB to execute said manager task.

12. The system according to claim 11, further comprising:
said global CORBA ORB receiving a global task created within said global CORBA ORB;
said global CORBA ORB executing said global task; and
in response to executing said global task by said global CORBA ORB, said global CORBA ORB downloading said manager task to said first CORBA ORB.

13. The system according to claim 11, further comprising:
said global CORBA ORB receiving said manager task created within said global CORBA ORB to distribute a software application to said second and third CORBA ORBs;
said global CORBA ORB downloading said manager task to said first CORBA ORB;
said global CORBA ORB causing said first CORBA ORB to execute said manager task; and
in response to said first CORBA ORB executing said manager task, said first CORBA ORB distributing said software application to said second and third CORBA ORBs.

14. The system according to claim 10, further comprising:
said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy; and
said global CORBA ORB retrieving names from said first plurality of first-level CORBA ORBs of said second-level and third level CORBA ORBs.

15. The system according to claim 14, further comprising:
said global CORBA ORB receiving a manager task created within said global CORBA ORB;
said global CORBA ORB downloading said manager task to said first plurality of first-level CORBA ORB; and
said global CORBA ORB causing said first plurality of first-level CORBA ORBs to execute said manager task.

16. The system according to claim 15, further comprising:
means for creating said manager task to distribute a software application to said second plurality and third plurality of CORBA ORBs; and
in response to said first plurality of CORBA ORBs executing said manager task, said first CORBA ORBs distributing said software application to said second plurality and third plurality of CORBA ORBs.

17. The system according to claim 16, further comprising:
said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy;
said global CORBA ORB obtaining a copy of a profile manager stored in ones of said first plurality of CORBA ORBs;
each said profile manager including names of ones of said second plurality and ones of said third plurality of CORBA ORBs;
said global CORBA ORB receiving a manager task created within said global CORBA ORB;
said global CORBA ORB downloading said manager task to said ones of said first plurality of CORBA ORB;
said global CORBA ORB causing said ones of said first plurality of CORBA ORBs to execute said manager task; and
said manager task being executed by said ones of said first plurality of CORBA ORBs which performs an action utilizing said ones of said second plurality and said ones of said third plurality of CORBA ORBs.

18. The system according to claim 10, further comprising:
said global CORBA ORB obtaining a copy of a profile manager stored in said first CORBA ORB; and
said profile manager including a name of said second and third CORBA ORBs.

19. A computer program product in a data processing system for providing a four-tier CORBA architecture, said product comprising:
instruction means for providing a three-tier CORBA network, said CORBA network including a first CORBA ORB coupled to a second CORBA ORB, said second CORBA ORB being coupled to a third CORBA ORB, wherein said first CORBA ORB occupies a first level of a network hierarchy, said second CORBA ORB occupies a second level of said network hierarchy, and said third CORBA ORB occupies a third level of said network hierarchy; and
instruction means for coupling a global CORBA ORB to said three-tier CORBA network, said global CORBA ORB occupies a top level of said network hierarchy over said first level, said global CORBA ORB functioning as a CORBA ORB and treating said first CORBA ORB as a managed node.

20. The product according to claim 19, further comprising:
instruction means for creating, on said global CORBA ORB, a manager task;
instruction means for downloading, from said global CORBA ORB, said manager task to said first CORBA ORB; and
instruction means for causing, by said global CORBA ORB, said first CORBA ORB to execute said manager task.

21. The product according to claim 20, further comprising:
instruction means for creating, on said global CORBA ORB, a global task;
instruction means for executing, by said global CORBA ORB, said global task; and
in response to executing said global task by said global CORBA ORB, instruction means for downloading said manager task to said first CORBA ORB.

22. The product according to claim 20, further comprising:
instruction means for creating, on said global CORBA ORB, said manager task to distribute a software application to said second and third CORBA ORBs;
instruction means for downloading, from said global CORBA ORB, said manager task to said first CORBA ORB;
instruction means for causing, by said global CORBA ORB, said first CORBA ORB to execute said manager task; and
in response to said first CORBA ORB executing said manager task, instruction means for distributing, by said first CORBA ORB, said software application to said second and third CORBA ORBs.

23. The product according to claim 19, further comprising:
instruction means for providing said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy; and
instruction means for retrieving, by said global CORBA ORB, names from said first plurality of first-level CORBA ORBs of said second-level and third level CORBA ORBs.

24. The product according to claim 23, further comprising:
instruction means for creating, on said global CORBA ORB, a manager task;
instruction means for downloading, from said global CORBA ORB, said manager task to said first plurality of first-level CORBA ORB; and
instruction means for causing, by said global CORBA ORB, said first plurality of first-level CORBA ORBs to execute said manager task.

25. The product according to claim 24, further comprising:
instruction means for creating said manager task to distribute a software application to said second plurality and third plurality of CORBA ORBs; and
in response to said first plurality of CORBA ORBs executing said manager task, instruction means for distributing, by said first CORBA ORBs, said software application to said second plurality and third plurality of CORBA ORBs.

26. The product according to claim 25, further comprising:
instruction means for providing said three-tier CORBA network including a first plurality of first-level CORBA ORBs, a second plurality of second-level CORBA ORBs, and a third plurality of third-level CORBA ORBs, said first-level CORBA ORBs occupying said first level of said network hierarchy, said second-level CORBA ORBs occupying said second level of said network hierarchy, and said third-level CORBA ORBs occupying said third level of said network hierarchy;
instruction means for obtaining, by said global CORBA ORB, a copy of a profile manager stored in ones of said first plurality of CORBA ORBs;
each said profile manager including names of ones of said second plurality and ones of said third plurality of CORBA ORBs;
instruction means for creating, on said global CORBA ORB, a manager task;
instruction means for downloading, from said global CORBA ORB, said manager task to said ones of said first plurality of CORBA ORB;
instruction means for causing, by said global CORBA ORB, said ones of said first plurality of CORBA ORBs to execute said manager task; and
instruction means for executing said manager task by said ones of said first plurality of CORBA ORBs which performs an action utilizing said ones of said second plurality and said ones of said third plurality of CORBA ORBs.

27. The product according to claim 19, further comprising:
instruction means for obtaining, by said global CORBA ORB, a copy of a profile manager stored in said first CORBA ORB; and
said profile manager including a name of said second and third CORBA ORBs.
